(19) United States
(12) Patent Application Publication
(10) Pub. No.: US 2007/0115095 A1
(43) Pub. Date: May 24, 2007

(54) OCCUPANT APPROACH DETECTION APPARATUS, OCCUPANT APPROACH DETECTION SYSTEM, AND OCCUPANT APPROACH DETECTION METHOD

(75) Inventor: Takashi Eguchi, Fujisawa-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/561,430

(22) Filed: Nov. 20, 2006

(30) Foreign Application Priority Data
Nov. 21, 2005 (JP) 2005-335321

(51) Int. Cl. G05B 19/00

(52) U.S. Cl. 340/5.61; 340/5.72; 340/426.36; 340/425.5

(57) ABSTRACT

An occupant approach detection apparatus which includes: a transmitting device individually transmitting transmission request signals from transmitting antennas provided to doors of a vehicle; a receiving device receiving a response signal returned, as a response to one of the transmission request signals, from a portable unit; and a controller detecting an approach of a vehicle occupant carrying the portable unit based on the response signal. Each of the transmission request signals includes identification information for identifying corresponding one of the transmitting antennas or one of the doors. The response signal includes identification information corresponding to the identification information included in the transmission request signal. The controller determines which of the plurality of doors is approached by the vehicle occupant carrying the portable unit on the basis of the identification information included in the response signal.

### BACKGROUND OF THE INVENTION

1. Field of Invention

The present invention relates to an occupant approach detection apparatus, an occupant approach detection system and an occupant approach detection method which detect a vehicle occupant approaching the vehicle.

2. Description of Related Art

There is a technology for detecting a vehicle occupant, who carries a portable unit, approaching the vehicle by performing radio communication between an on-vehicle unit mounted on the vehicle and the portable unit carried by the occupant. Such a technology is used as an element technology, for example, in a so-called smart entry system, which automatically locks/unlocks doors of the vehicle according to the occupant's approach or departure. In the smart entry system, it is desirable that only the door approached by the occupant be locked or unlocked. In order to achieve this, proposed is a technology for detecting, from a plurality of doors of the vehicle, a door approached by the occupant carrying the portable unit.

The Japanese Patent Application Laid-open Publication No. H10 (1998)-317754 discloses a technology in which transmission request signals are sequentially transmitted, in a time-division manner, from a plurality of transmitting antennas respectively provided to the plurality of doors of the vehicle in a corresponding manner. It is then determined at which timing a response signal is received from the portable unit carried by the vehicle occupant, the response signal responding to the sent transmission request signal. Accordingly, detection is made for a door which is one of the plurality of doors, and which is approached by the vehicle occupant.

### SUMMARY OF THE INVENTION

However, with the aforementioned technology, the transmission request signals are sequentially transmitted, in the time-division manner, from the plurality of transmitting antennas in order to determine a door which is one of the plurality of doors, and which is approached by the vehicle occupant. Accordingly, it is necessary to set a period of operation time long enough for a controller which drives and controls the transmitting antennas, and to set a period of standby time long enough for a receiver which receives the response signal from the portable unit. For this reason, there is a problem that power consumption of the controller and of the receiver increases.

The present invention has been made to solve the aforementioned problem, and an object of the invention is to provide an occupant approach detection apparatus, an occupant approach detection system, and an occupant approach detection method with which it is made possible to determine a door, which is one of a plurality of doors, and which is approached by a vehicle occupant carrying a portable unit, without increasing the power consumption.

An aspect of the present invention is an occupant approach detection apparatus, comprising: a transmitting device which individually transmit transmission request signals from a plurality of transmitting antennas provided to a plurality of doors of a vehicle in a corresponding manner; a receiving device which receives a response signal returned, as a response to one of the transmission request signals, from a portable unit having received the relevant transmission request signal; and control device which controls operations of the transmitting device and the receiving device, and which detects an approach of a vehicle occupant carrying the portable unit based on the response signal received by the receiving device, wherein each of the transmission request signals transmitted from the plurality of transmitting antennas includes identification information for identifying a corresponding one of the transmitting antennas or a corresponding one of the doors provided with the corresponding one of the transmitting antennas, and the response signal includes identification information corresponding to the identification information included in the transmission request signal received by the portable unit, and the control device determines which of the plurality of doors is approached by the vehicle occupant carrying the portable unit on the basis of the identification information included in the response signal received from the portable unit by the receiving device.

### BRIEF DESCRIPTION OF THE DRAWINGS

The invention will now be described with reference to the accompanying drawings wherein:

FIG. 1 is a system configuration diagram for schematically showing an entire configuration of a vehicle door lighting system to which the present invention is applied.

FIG. 2 is a schematic view for showing an example of placement positions of first to third transmitting antennas and detection areas formed by driving the respective transmitting antennas.

FIG. 3 is a diagram for showing an example of a format of transmission request signals transmitted from the first to third transmitting antennas.

FIG. 4 is a diagram for showing an example of a format of response signals returned from a portable unit as a response to one of the transmission request signals.

FIG. 5 is a flowchart for showing a flow of a process periodically executed by a control circuit of a control unit of an on-vehicle unit in the vehicle door lighting system to which the present invention is applied.

FIG. 6 is a flowchart for showing a flow of a process executed by the portable unit in the vehicle door lighting system to which the present invention is applied.

FIG. 7 is a time chart for explaining that the control unit needs a longer period of time for start-up in a case where a plurality of transmitting antennas are sequentially driven in a time-division manner.

FIG. 8 is a time chart for explaining that power consumption is reduced by shortening the start-up time for the control unit in the vehicle door lighting system to which the present invention is applied.

FIG. 9 is a system configuration diagram for schematically showing an entire configuration of a smart entry system to which the present invention is applied.

### DETAILED DESCRIPTION OF THE PREFERRED EMBODIMENT

Embodiments of the present invention will be explained below with reference to the drawings, wherein like members are designated by like reference characters.

### First Embodiment

First, as a first embodiment of the present invention, descriptions are provided for an example of a vehicle door lighting system to which the present invention is applied. In the example, lights illuminating around a plurality of doors of a vehicle are provided to the respective doors in a corresponding manner. When a vehicle occupant approaches any one of the doors, a light, which is provided to the approached door in a corresponding manner, is turned on to provide hospitality.

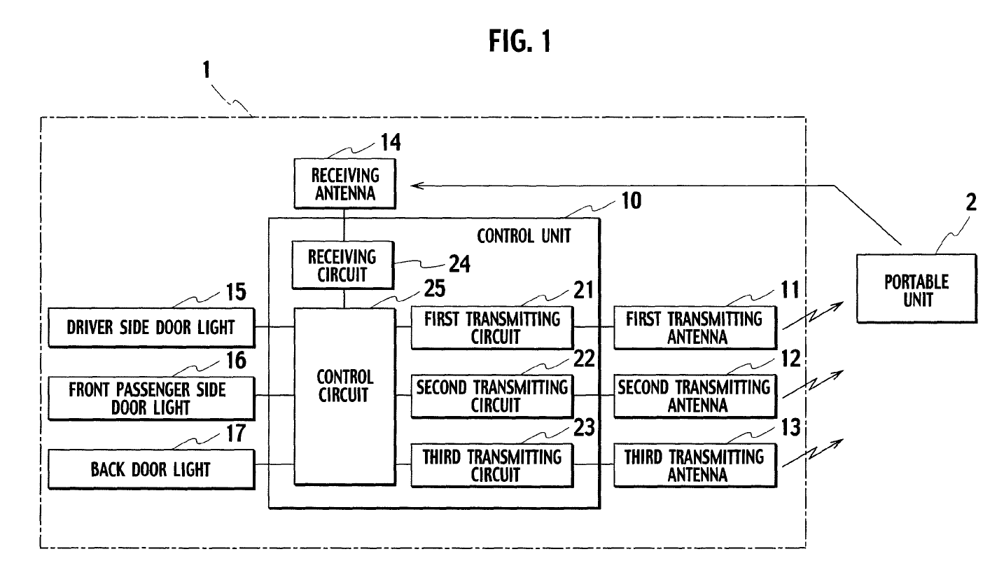

FIG. 1 is a system configuration diagram for schematically showing an entire configuration of the vehicle door lighting system according to the first embodiment of the present invention. As shown in FIG. 1, the vehicle door lighting system of the first embodiment includes an on-vehicle unit 1, which is mounted on the vehicle, and a portable unit 2, which is carried by the vehicle occupant, and performs radio communication between the on-vehicle unit 1 and the portable unit 2 to implement the aforementioned lighting control of the lights.

In the vehicle door lighting system of the first embodiment, the on-vehicle unit 1 mounted on the vehicle includes a control unit 10 as a main constituent. This control unit 10 is connected to first to third three transmitting antennas 11, 12 and 13 and to a receiving antenna 14. Moreover, the control unit 10 is also connected to a driver side door light 15, which illuminates around a door at a side of a driver's seat of the vehicle, a front passenger side door light 16, which illuminates around a door at a side of a front passenger's seat of the vehicle, and a back door light 17, which illuminates around a back door of the vehicle. Turning on and off of these lights 15, 16 and 17 are controlled by the control unit 10.

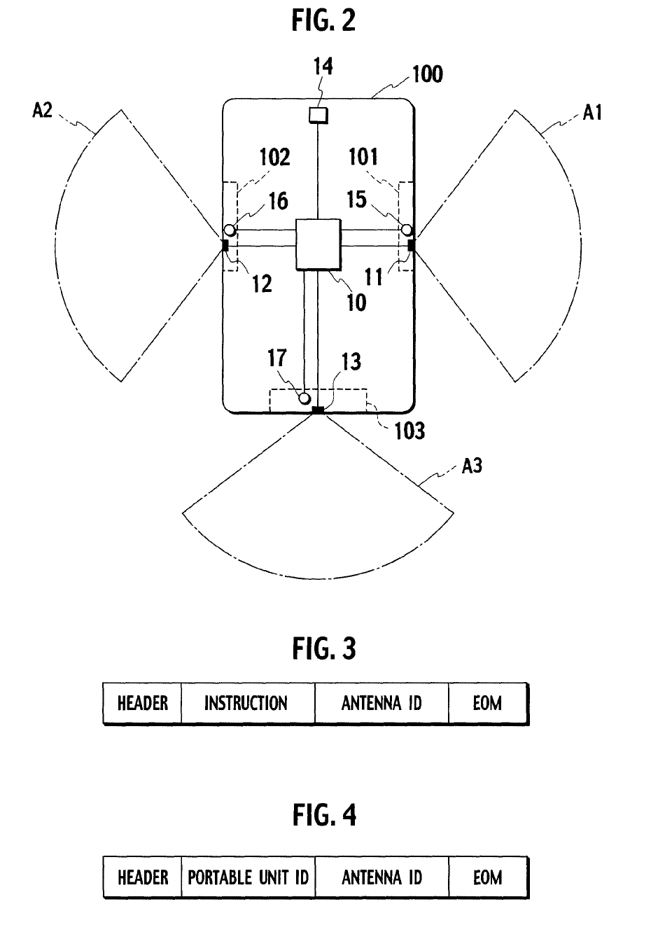

Among the three transmitting antennas 11, 12 and 13 provided to the on-vehicle unit 1, the first transmitting antenna 11 is placed, for example, as shown in FIG. 2, in a door 101 at the side of the driver's seat of a vehicle 100, on which the on-vehicle unit 1 is mounted. When driven, the first transmitting antenna 11 forms a detection area A1 in the vicinity of the door 101 at the side of the driver's seat. The second transmitting antenna 12 is placed in a door 102 at the side of the front passenger's seat of the vehicle 100. When driven, the second transmitting antenna 12 forms a detection area A2 in the vicinity of the door 102 at the side of the front passenger's seat. The third transmitting antenna 13 is placed in a back door 103 of the vehicle 100. When driven, the third transmitting antenna 13 forms a detection area A3 in the vicinity of the back door 103. These detection areas A1, A2 and A3 are respectively ranges where the transmission request signals reach, the transmission request signals being transmitted, as radio waves, from the respective first to third transmitting antennas 11 to 13. In other words, these ranges are areas where radio communication is possible between the on-vehicle unit 1 and the portable unit 2. When the vehicle occupant carrying the portable unit 2 enters one of the detection areas A1, A2 and A3, the on-vehicle unit 1 receives a response signal from the portable unit 2.

The driver side door light 15, the front passenger side door light 16 and the back door light 17 are placed on door handles, under door mirrors, or the like, of the doors 101, 102 and 103 so as to illuminate around the doors 101, 102 and 103, respectively.

As shown in FIG. 10, transmitting circuits 21, 22 and 23 are provided as first to third transmitting devices/transmission means, which respectively correspond to the first to third transmitting antennas 11, 12 and 13, in the control unit 10. Moreover, a receiving circuit 24 and a control circuit 25 are provided in the control unit 10. The receiving circuit 24, as a receiving device/reception means, corresponds to the receiving antenna 14. The control circuit 25, as a control device/control means, controls over an entire operation of the on-vehicle unit 1. The control circuit 25 is configured as a microcomputer including a CPU, a ROM, a RAM and the like. The control circuit 25 executes a process based on a predetermined operation control program to control operations of the first to third transmitting circuits 21, 22 and 23 as well as the receiving circuit 24, and to control turning on and off of the driver side door light 15, the front passenger side door light 16 and the back door light 17.

The control circuit 25 of the control unit 10 is supplied with power from a battery at a predetermined frequency, and repeatedly starts and stops on a periodic basis while the vehicle 100, on which the on-vehicle unit 1 is mounted, is parked with an ignition switch of the vehicle 100 being off. While being activated, the control circuit 25 operates the first to third transmitting circuits 21 to 23 at a predetermined cycle, and causes the first to third transmitting circuits 21 to 23 to respectively transmit transmission request signals from the first to third transmitting antennas 11 to 13, the transmission request signals corresponding to the transmitting circuits 21 to 23. As shown in FIG. 2, the detection areas A1 to A3 are thus formed in the vicinities of the driver side door 101, front passenger side door 102 and the back door 103, respectively. Accordingly, radio communication between the on-vehicle unit 1 and the portable unit 2 is made possible.

The transmission request signals, which the first to third transmitting circuits 21 to 23 respectively transmit from the first to third transmitting antennas 11 to 13 under the control of the control circuit 25, are request signals to request a response from the portable unit 2. In this event, especially in the vehicle door lighting system of the first embodiment, the transmission request signals, which are respectively transmitted from these first to third antennas 11 to 13, are configured to include individual antenna IDs as information for identifying the respective transmitting antennas 11 to 13. Specifically, each of the transmission request signals, which are transmitted from the transmitting antennas 11 to 13, has a format shown in FIG. 3, for example. In the format, in addition to an instruction for requesting the response signal from the portable unit 2, an antenna ID as identification information of the transmitting antenna, from which the transmission request signal is transmitted, is written in a data area between a header and an EOM (End of Message). In the transmission request signal transmitted from the first transmitting antenna 11 by the first transmitting circuit 21, the antenna ID of the first transmitting antenna 11 is written in the data area. In the transmission request signal transmitted from the second transmitting antenna 12 by the second transmitting circuit 22, the antenna ID of the second transmitting antenna 12 is written in the data area. In the transmission request signal transmitted from the third transmitting antenna 13 by the third transmitting circuit 23, the antenna ID of the third transmitting antenna 13 is written in the data area.

While being activated, the control circuit 25 of the control unit 10 causes the transmission request signals to be transmitted from the first to third transmitting antennas 11 to 13. Thereafter, the control circuit 25 sets the receiving circuit 24 in a state of standby for a predetermined time, and causes the receiving circuit 24 to receive the response signal, which is returned from the portable unit 2, as a response to one of the transmission request signals. While being activated at the predetermined cycle, the control unit 10 repeats the above control of transmitting the transmission request signals and of waiting for the response signal until the response signal from the portable unit 2 is received.

When the transmission request signal, which is transmitted from one of the first to third transmitting antennas 11 to 13, is received, the portable unit 2, which is carried by the vehicle occupant, returns the response signal as a response to the received transmission request signal. Specifically, when the portable unit 2 in the detection area A1 in the vicinity of the driver side door 101 of the vehicle 100 receives the transmission request signal from the first transmitting antenna 11, the portable unit 2 returns the response signal as a response to the transmission request signal from the first transmitting antenna 11. When the portable unit 2 in the detection area A2 in the vicinity of the front passenger side door 102 of the vehicle 100 receives the transmission request signal from the second transmitting antenna 12, the portable unit 2 returns the response signal as a response to the transmission request signal from the second transmitting antenna 12. When the portable unit 2 in the detection area A3 in the vicinity of the back door 103 of the vehicle 100 receives the transmission request signal from the third transmitting antenna 13, the portable unit 2 returns the response signal as a response to the transmission request signal from the third transmitting antenna 13.

In this event, especially in the vehicle door lighting system of the first embodiment, the response signal, which is returned from the portable unit 2 as the response to the transmission request signals, is configured to include the antenna ID (or identification information corresponding to the antenna ID) identical to that included in the received transmission request signal. Specifically, the response signal returned from the portable unit 2 has a format shown in FIG. 4, for example. In addition to a portable unit ID as identification information of the portable unit 2, the antenna ID, which is identical to that included in the received transmission request signal, is written in a data area between a header and an EOM (End of Message). Specifically, in the response signal returned from the portable unit 2 within the detection area A1 in the vicinity of the driver side door 101 of the vehicle 100, the antenna ID, which indicates the first transmitting antenna 11, is written. In the response signal returned from the portable unit 2 within the detection area A2 in the vicinity of the front passenger side door 102 of the vehicle 100, the antenna ID, which indicates the second transmitting antenna 12, is written. In the response signal returned from the portable unit 2 within the detection area A3 in the vicinity of the back door 103 of the vehicle 100, the antenna ID, which indicates the third transmitting antenna 13, is written.

When the response signal is received from the portable unit 2 by means of the receiving circuit 24, the control circuit 25 of the control unit 10 verifies the portable unit ID included in the response signal with a portable unit ID previously registered to perform user authentication according to whether the portable unit ID included in the response signal from the portable unit 2 matches the portable unit ID previously registered. In a case where the portable unit ID included in the response signal from the portable unit 2 matches the portable unit ID previously registered, the control circuit 25 determines that a legitimate user (the vehicle occupant who owns the portable unit 2) exists in the detection area.

When it is determined that the vehicle occupant, who is the legitimate user, exists in the detection area, the control circuit 25 of the control unit 10 reads the antenna ID included in the response signal from the portable unit 2, and determines to which of the transmission request signals respectively transmitted from the first to third transmitting antennas 11 to 13 the response signal from the portable unit 2 is a response, i.e., in which of the detection areas A1 to A3 the vehicle occupant carrying the portable unit 2 exists. According to a determination result, the control circuit 25 performs control of turning on only a light, which is one of the driver side door light 15, front passenger side door light 16, and back door light 17, and which corresponds to the door approached by the vehicle occupant carrying the portable unit 2.

Specifically, in a state where the transmission request signals are respectively transmitted from the first to third transmitting antennas 11 to 13, it is supposed that the vehicle occupant carrying the portable unit 2 enters the detection area A1 formed in the vicinity of the driver side door 101 of the vehicle 100. The transmission request signal transmitted from the first transmitting antenna 11 is received by the portable unit 2, and the response signal, which is returned from the portable unit 2 as a response to the transmission request signal, includes the antenna ID indicating the first transmitting antenna 11. When the antenna ID, which is included in the response signal from the portable unit 2, indicates the first transmitting antenna 11, the control circuit 25 determines that the vehicle occupant carrying the portable unit 2 has entered the detection area A1, and that the occupant is approaching the driver side door 101 of the vehicle 100. The control circuit 25 then turns on the driver side door light 15. In a state where the transmission request signals are respectively transmitted from the first to third transmitting antennas 11 to 13, when the vehicle occupant carrying the portable unit 2 enters the detection area A2 formed in the vicinity of the front passenger side door 102 of the vehicle 100, the transmission request signal transmitted from the second transmitting antenna 12 is received by the portable unit 2, and the response signal, which is returned from the portable unit 2 as a response to the transmission request signal, includes the antenna ID indicating the second transmitting antenna 12. When the antenna ID included in the response signal from the portable unit 2 indicates the second transmitting antenna 12, the control circuit 25 determines that the vehicle occupant carrying the portable unit 2 has entered the detection area A2, and that the occupant is approaching the front passenger side door 102 of the vehicle 100. The control circuit 25 then turns on the front passenger side door light 16. In a state where the transmission request signals are respectively transmitted from the first to third transmitting antennas 11 to 13, when the vehicle occupant carrying the portable unit 2 enters the detection area A3 formed in the vicinity of the back door 103 of the vehicle 100, the transmission request signal transmitted from the third transmitting antenna 13 is received by the portable unit 2, and the response signal, which is returned from the portable unit 2 as a response to the transmission request signal, includes the antenna ID indicating the third transmitting antenna 13. When the antenna ID included in the response signal from the portable unit 2 indicates the third transmitting antenna 13, the control circuit 25 determines that the vehicle occupant carrying the portable unit 2 has entered the detection area A3, and that the occupant is approaching the back door 103 of the vehicle 100. The control circuit 25 then turns on the back door light 17.

As described above, in the vehicle door lighting system of the first embodiment, it is determined which door is approached by the vehicle occupant by confirming the antenna ID included in the response signal, which is returned from the portable unit 2 carried by the vehicle occupant, as a response to one of the transmission request signals respectively transmitted from the first to third transmitting antennas 11 to 13 of the on-vehicle unit 1. When the vehicle occupant approaches one of the doors, a light, which is one of the driver side door light 15, the front passenger side door light 16 and the back door light 17, and which is provided to the door approached by the vehicle occupant in a corresponding manner, is turned on, thus providing hospitality.

Moreover, after the light, which is provided to the door approached by the vehicle occupant in a corresponding manner, is turned on, the vehicle door lighting system of the first embodiment may be configured to perform control of unlocking a door lock unit provided to the relevant door. In this case, since the door approached by the vehicle occupant is already known, the door lock unit provided to the door may be automatically unlocked. Alternatively, the door lock unit provided to the door may be unlocked after user authentication is again performed by communication between the on-vehicle unit 1 and the portable unit 2, the user authentication being triggered by a switch provided in the vicinity of a door handle of the door being operated. Such repeated user authentication by the communication between the on-vehicle unit 1 and the portable unit 2 makes it possible to unlock the relevant door at the timing at which the vehicle occupant, who is the legitimate user, is clearly approaching the door illuminated by turning on the light. Hence, it is highly effective in improving security.

Moreover, any one of a plurality of door lock units can be freely set to be unlocked. For example, in a case where it is determined that the vehicle occupant, who is the legitimate user, approaches the driver side door, all of the door lock units, which are respectively provided to the doors of the vehicle, may be unlocked. In a case where it is determined that the occupant approaches the front passenger side door or the back door, only the door lock unit of the relevant door may be unlocked.

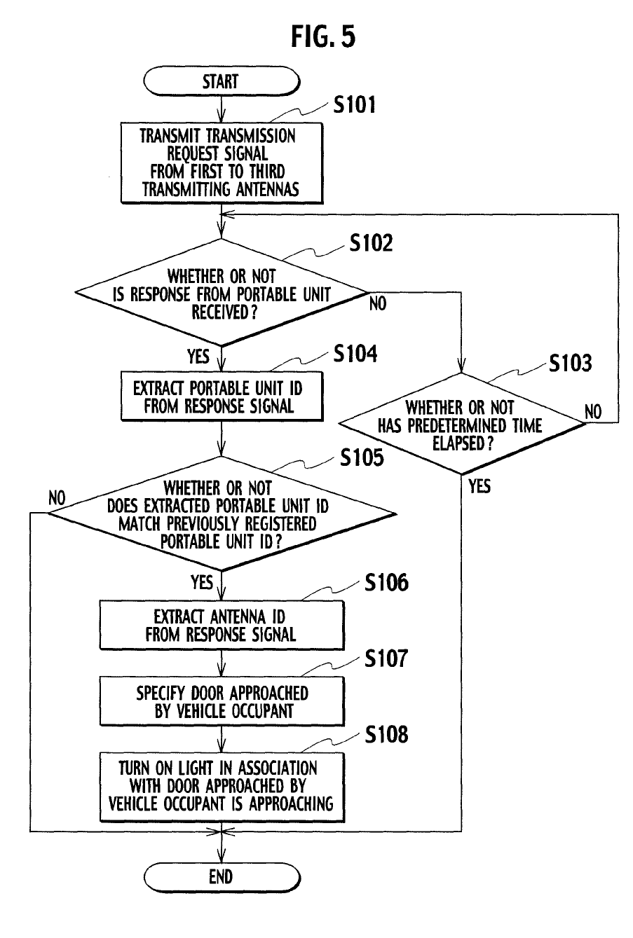

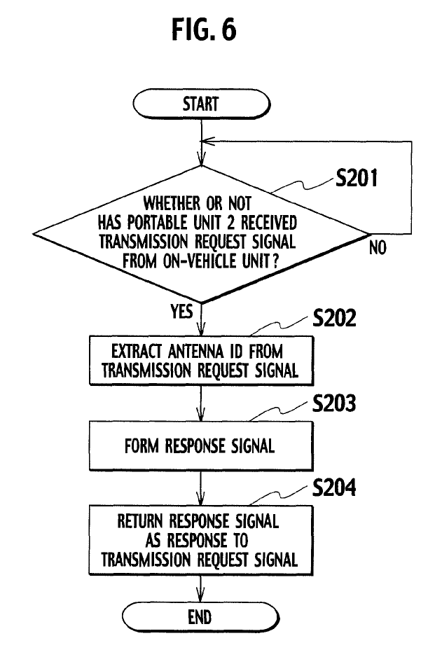

Descriptions will be provided for a series of operations in the vehicle door lighting system of the first embodiment with reference to flowcharts of FIGS. 5 and 6. FIG. 5 is a flowchart for showing a flow of a process periodically executed by the control circuit 25 in the control unit 10 of the on-vehicle unit 1, and FIG. 6 is a flowchart for showing a flow of a process executed by the portable unit 2.

In the vehicle door lighting system of the first embodiment, as shown in the flowchart of FIG. 5, when the control circuit 25 in the control unit 10 of the on-vehicle unit 1 is supplied with power from the on-vehicle battery to be activated while the vehicle is parked, in step S101, the control circuit 25 first operates and causes the first to third transmitting circuits 21 to 23 to respectively transmit, from the first to third transmitting antennas 11 to 13, the transmission request signals including the individual antenna IDs as identification information of the respective antennas. Next, in step S102, the control circuit 25 operates the receiving circuit 24, and determines whether the response signal from the portable unit 2 is received by the receiving circuit 24. The determination in this step S102 is repeated until it is determined, in step S103, that a predetermined period of time (standby time) has elapsed. When the response signal from the portable unit 2 is received by the receiving circuit 24 within the predetermined period of time, the process proceeds to step S104. When the predetermined period of time elapses before the response signal from the portable unit 2 is received by the receiving circuit 24, the control circuit 25 is made to be in a sleep state (a state where the power supply is stopped) until the next activation cycle.

Meanwhile, as shown in the flowchart of FIG. 6, the portable unit 2 carried by the vehicle occupant constantly determines whether the portable unit 2 receives the transmission request signal from the on-vehicle unit 1 (step S201). In step S202, when the transmission request signal is received from the on-vehicle unit 1, the portable unit 2 reads the antenna ID from the received transmission request signal. In step S203, The portable unit 2 forms a response signal, in which the antenna ID read from the received transmission request signal and the portable unit ID are incorporated, as identification information of the portable unit 2. In step S204, the portable unit 2 returns the response signal, which is formed in the step S203, as a response to the received transmission request signal from the on-vehicle unit 1.

Subsequently, in step S104, when the response signal is received from the portable unit 2 by the receiving circuit 24, the control circuit 25 in the control unit 10 of the on-vehicle unit 1 reads the portable unit ID included in the response signal received from the portable unit 2. Thereafter, in step S105, the control circuit 25 determines whether the portable unit ID, which is included in the response signal, matches the portable unit ID previously registered as the portable unit ID of the legitimate user. In a case where the portable unit ID, which is included in the response signal from the portable unit 2, does not match the portable unit ID previously registered, the control circuit 25 directly terminates the process. In a case where the portable unit ID, which is included in the response signal from the portable unit 2, matches the portable unit ID previously registered, the control circuit 25 reads, in step S106, the antenna ID included in the response signal from the portable unit 2. In step S107, based on the antenna ID read in the step S106, the control circuit 25 specifies the door, which is one of the driver side door, the front passenger side door, and the back door of the vehicle, and which is approached by the vehicle occupant carrying the portable unit 2. In next step S108, the control circuit 25 performs control of turning on a light which is one of the driver side door light 15, front passenger side door light 16 and back door light 17, and which corresponds to the door specified, in the step S106, to be one approached by the vehicle occupant.

As described above, in the vehicle door lighting system of the first embodiment, the transmission request signals transmitted to the portable unit 2 respectively from the first to third transmitting antennas 11 to 13, which are provided to the driver side door, the front passenger side door, and the back door in a corresponding manner, are configured to include the individual antenna IDs as identification information on the respective transmitting antennas 11 to 13. Moreover, the response signal returned from the portable unit 2, by which one of the transmission request signals is received as a response to the transmission request signal, is configured to include the antenna ID (or identification information corresponding to the antenna ID) identical to the antenna ID included in the received transmission request signal. Based on the antenna ID included in the response signal which is returned from the portable unit 2, and which is received by the receiving circuit 24, the control circuit 25 in the control unit 10 of the on-vehicle unit 1 determines which of the driver side door, the front passenger side door and the back door of the vehicle is approached by the vehicle occupant, and turns on the light corresponding to the door which is determined to be the door approached by the vehicle occupant.

According to the vehicle door lighting system of the first embodiment, even when the transmission request signals are simultaneously transmitted from the first to third transmitting antennas 11 to 13, it is apparent, from the antenna ID included in the response signal from the portable unit 2, which of the transmitting antennas transmits the transmission request signal received by the portable unit 2. Accordingly, it is made possible to reliably determine which door is approached by the vehicle occupant carrying the portable unit 2, and to properly perform control of turning on the light corresponding to the door approached by the vehicle occupant without increasing power consumption.

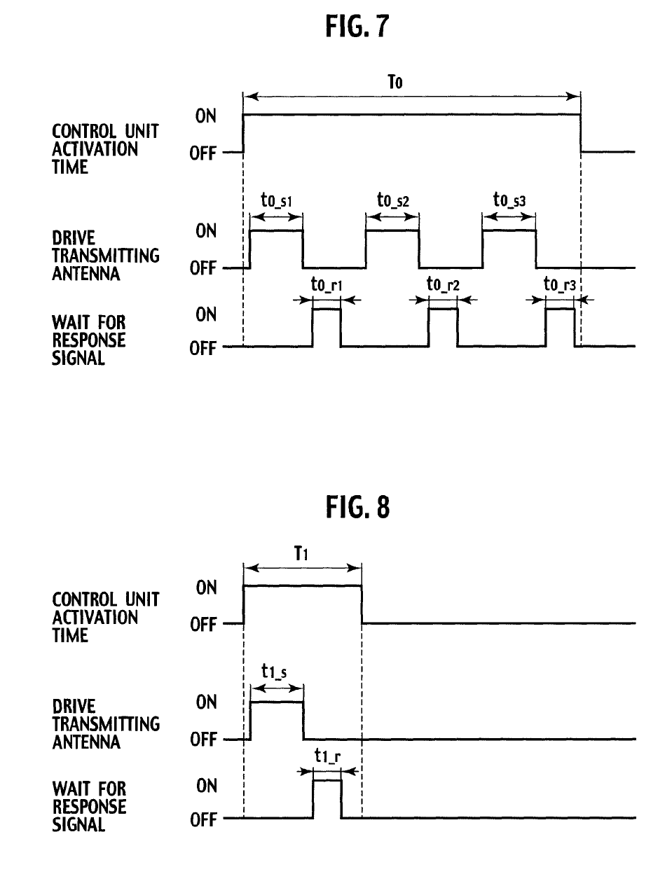

Specifically, as a method of determining which of the plurality of doors is approached by the vehicle occupant, another method can be considered as described below. Transmission request signals are sequentially transmitted respectively from a plurality of transmitting antennas, which are provided, in a corresponding manner, to the plurality of doors in a time division manner (at timings of t0_s1, t0_s2, and t0_s3 in FIG. 7). Thereafter, it is determined which timing the transmission request signal is transmitted and the response signal corresponding to the transmission request signal is received from the portable unit carried by the vehicle occupant. As shown in FIG. 7, however, with such a method, receivers need to be individually operated at several timings (t0_r1, t0_r2, and t0_r3 in FIG. 7) according to the respective timings at which the transmitting antennas are driven. Moreover, the receivers need to be in a state of waiting for a response signal from the portable unit. It is therefore demanded that an activation time T₀ of the control unit be longer between each of the cycle, the activation time T₀ being the period of time when the control unit is periodically activated while the vehicle is parked. Accordingly, the power consumption is increased.

On the other hand, in the vehicle door lighting system of the first embodiment, the transmission request signals are simultaneously (at a timing of time t1_s in FIG. 8) transmitted from the first to third transmitting antennas 11 to 13. Accordingly, a period of time t1_r for the receiving circuit 24 to wait for the response signal from the portable unit 2 may be short, and activation time T₁ of the control unit 10 can be set shorter. Hence, according to the vehicle door light system, it is made possible to reliably determine which door is approached by the vehicle occupant carrying the portable unit 2, and to properly perform control of turning on the light which corresponds to the door approached by the vehicle occupant while reducing power consumption. In particular, the vehicle door lighting system of the first embodiment operates with power supplied from the on-vehicle battery in a state where the vehicle is parked, and thus where the on-vehicle battery is not further charged. Accordingly, such reduction in power consumption has great significance from the viewpoint of prevention of problems such as running out of the on-vehicle battery.

### Second Embodiment

Next, descriptions are provided for an example of a smart entry system to which the present invention is applied as a second embodiment of the present invention. With this smart entry system, when a vehicle occupant approaches one of the doors, a door lock unit, which is provided to the relevant door in a corresponding manner, is automatically unlocked.

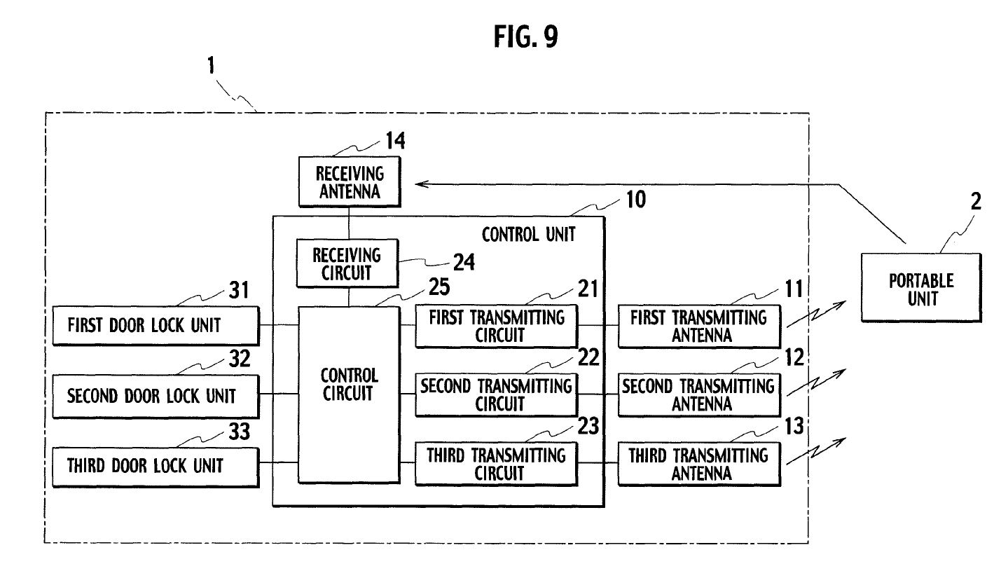

FIG. 9 is a system configuration diagram for schematically showing an entire configuration of the smart entry system as the second embodiment of the present invention. As shown in FIG. 9, the smart entry system of the second embodiment has a configuration substantially similar to the aforementioned vehicle door lighting system (see FIG. 1) of the first embodiment. In the second embodiment, the electric equipment, which is controlled by the on-vehicle unit 1, is different from that of the first embodiment. Specifically, in the vehicle door lighting system of the first embodiment, the driver side door light 15, the front passenger side door light 16 and the back door light 17 are controlled by the on-vehicle unit 1. On the other hand, in the smart entry system of the second embodiment, a first door lock unit 31, which is provided to the driver side door, a second door lock unit 32, which is provided to the front passenger side door, and a third door lock unit 33, which is provided to the back door, are controlled by the on-vehicle unit 1.

Other constituents in the smart entry system of the second embodiment are identical to those of the vehicle door lighting system of the first embodiment. Hereinafter, the identical constituents as those of the vehicle door lighting system of the first embodiment are denoted by the identical reference numerals, and the detailed descriptions thereof are omitted.

In the smart entry system of the second embodiment, as in the case of the vehicle door lighting system of the aforementioned first embodiment, under control of the control circuit 25 in the control unit 10 of the on-vehicle unit 1, the first to third transmitting circuits 21 to 23 are operated to simultaneously transmit transmission request signals from the first to third transmitting antennas 11 to 13. In this event, the transmission request signals, which are respectively transmitted from the first to third transmitting antennas 11 to 13, include the individual antenna IDs for identifying the transmitting antennas.

When one of the transmission request signals, which are simultaneously transmitted from the first to third transmitting antennas 11 to 13 of the on-vehicle unit 1, is received, the portable unit 2, which is carried by the vehicle occupant, forms a response signal in which an antenna ID (or identification information corresponding to the antenna ID) identical to the antenna ID included in the received transmission request signal and the portable unit ID, as identification information of the portable unit 2, are incorporated. Thereafter, the portable unit 2 returns the formed response signal as a response to the received transmission request signal.

After the transmission request signals are respectively transmitted from the first to third transmitting antennas 11 to 13, the control unit 25 in the control unit 10 of the on-vehicle unit 1 operates and causes the receiving circuit 24 to be in a state of waiting for the response signal from the portable unit 2. When the response signal is received from the portable unit 2 by the receiving circuit 24, the control unit 25 reads the portable unit ID included in the response signal, and verifies the read portable unit ID with the portable unit ID previously registered. Accordingly, user authentication is performed according to whether the portable unit ID included in the response signal from the portable unit 2 matches the portable unit ID previously registered.

In a case where the portable unit ID included in the response signal from the portable unit 2 matches the portable unit ID previously registered, the control circuit 25 reads the antenna ID included in the response signal from the portable unit 2, and determines which of the first to third transmitting antennas 11 to 13 has transmitted the transmission request signal, to which the response from the portable unit 2 corresponds. That is, the control circuit 25 determines which of the driver side door, the front passenger side door and the back door is approached by the vehicle occupant carrying the portable unit. According to a determination result, the control circuit 25 performs control of unlocking only the door lock unit which corresponds to the door approached by the vehicle occupant carrying the portable unit 2, the door lock unit being one of the first door lock unit 31, which is provide to the driver side door, the second door lock unit 32, which is provided to the front passenger side door, and the third door lock unit 33, which is provided to the back door.

As described above, in the smart entry system of the second embodiment, the transmission request signals transmitted to the portable unit 2 from the first to third transmitting antennas 11 to 13, which are respectively provided to the driver side door, the front passenger side door and the back door of the vehicle in a corresponding manner, are configured to include the individual antenna IDs as identification information on the respective transmitting antennas 11 to 13. Moreover, the response signal, which is returned, as a response to the transmission request signal, by the portable unit 2, which has received one of the transmission request signals, is configured to include the antenna ID (or identification information corresponding to the antenna ID) identical to the antenna ID included in the received transmission request signal. Based on the antenna ID, which is included in the response signal returned from the portable unit 2, and which is received by the receiving circuit 24, the control circuit 25 in the control unit 10 of the on-vehicle unit 1 determines which of the driver side door, the front passenger side door and the back door of the vehicle is approached by the vehicle occupant, and unlocks the door lock unit corresponding to the door which is determined to be the door approached by the vehicle occupant.

According to the smart entry system of the second embodiment, among the transmission request signals simultaneously transmitted from the first to third transmitting antennas 11 to 13, the transmitting antenna, from which the transmission request signal received by the portable unit 2 is transmitted, is known from the antenna ID included in the response signal from the portable unit 2. Accordingly, as in the case of the aforementioned vehicle door lighting system of the first embodiment, it is made possible to reliably determine which door is approached by the vehicle occupant carrying the portable unit 2, and properly perform control of unlocking only the door lock unit corresponding to the door which is approached by the vehicle occupant without increasing the power consumption.

The above described vehicle door lighting system of the first embodiment and the smart entry system of the second embodiment are merely application examples of the present invention. It is obvious that the technical scope of the present invention is not limited by the contents disclosed in the above descriptions of the embodiments, and that the technical scope of the present inventions includes various alternative techniques which can be easily derived from these disclosures. For example, in the descriptions of the aforementioned embodiments, the transmission request signals respectively transmitted from the first to third transmitting antennas 11 to 13 are configured to include the individual antenna IDs as identification information on the respective transmitting antennas. However, instead of the antenna IDs, the transmission request signals may include identification information on the transmitting circuits corresponding to the respective transmitting antennas, or may include identification information on the doors of the vehicle corresponding to the respective transmitting antennas. In the descriptions of the aforementioned embodiments, the on-vehicle unit 1 transmits the transmission request signals respectively from three antennas, which are the first to third transmitting antennas 11 to 13, the transmission request signals being respectively corresponding to the three doors including the driver side door, the front passenger side door and the back door. However, the on-vehicle door 1 may transmit, for example, the transmission request signals from two transmitting antennas, the transmission request signals being respectively corresponding to two doors including the driver side door and the front passenger side door, or may transmit the transmission request signals from four or more transmitting antennas, the transmission request signals respectively corresponding to four or more doors. Furthermore, the descriptions of the aforementioned embodiments are provided for the lighting units and the door lock units, which are respectively provided to the individual doors in a corresponding manner, as examples of the electric equipment controlled by the control unit 10. However, the electric equipment is not limited to these, and the present invention can be applied to any one of electric equipment provided to the respective doors of the vehicle in a corresponding manner.

The present disclosure relates to subject matters contained in Japanese Patent Application No. 2005-335321, filed on Nov. 21, 2005, the disclosures of which is expressly incorporated herein by reference in its entirety.

What is claimed is:

1. An occupant approach detection apparatus, comprising:
a transmitting device which individually transmit transmission request signals from a plurality of transmitting antennas provided to a plurality of doors of a vehicle in a corresponding manner;
a receiving device which receives a response signal returned, as a response to one of the transmission request signals, from a portable unit having received the relevant transmission request signal; and
a control device which controls operations of the transmitting device and the receiving device, and which detects an approach of a vehicle occupant carrying the portable unit based on the response signal received by the receiving device,
wherein
each of the transmission request signals transmitted from the plurality of transmitting antennas includes identification information for identifying a corresponding one of the transmitting antennas or a corresponding one of the doors provided with the corresponding one of the transmitting antennas, and the response signal includes identification information corresponding to the identification information included in the transmission request signal received by the portable unit, and
the control device determines which of the plurality of doors is approached by the vehicle occupant carrying the portable unit on the basis of the identification information included in the response signal received from the portable unit by the receiving device.

2. The occupant approach detection apparatus according to claim 1, wherein the response signal further includes portable unit identification information for identifying the portable unit which has returned the response signal.

3. The occupant approach detection apparatus according to claim 2, wherein the control device operates electric equipment provided to one of the doors in a corresponding manner in a case where the portable unit identification information included in the response signal which is from the portable unit, and which is received with the receiving device, matches portable unit identification information previously registered, the door being determined to be a door which is approached by the vehicle occupant.

4. The occupant approach detection apparatus according to claim 3, wherein
the electric equipment is a plurality of lighting units provided to the plurality of doors in a corresponding manner, and
the control device turns on one of the lighting units which is provided in a corresponding manner to one of the doors in a case where the portable unit identification information included in the response signal which is from the portable unit, and which is received with the receiving device, matches the portable unit identification information previously registered, the door being determined to be the door which is approached by the vehicle occupant.

5. The occupant approach detection apparatus according to claim 3, wherein
the electric equipment is a plurality of door lock units provided to the plurality of doors in a corresponding manner, and
the control device unlocks one of the door lock units which is provided to one of the doors in a case where the portable unit identification information included in the response signal which is from the portable unit, and which is received with the receiving device, matches the portable unit identification information previously registered, the door being determined to be the door which is approached by the vehicle occupant.

6. An occupant approach detection system, comprising:
an on-vehicle unit which is mounted on a vehicle; and
a portable unit which is carried by a vehicle occupant, the on-vehicle unit communicating with the portable unit to detect an approach to the vehicle by the vehicle occupant carrying the portable unit,
wherein
the on-vehicle unit includes:
a transmitting device which individually transmit transmission request signals from a plurality of transmitting antennas provided to a plurality of doors of a vehicle in a corresponding manner;
a receiving device which receives a response signal returned, as a response to one of the transmission request signals, from a portable unit having received the relevant transmission request signal; and
a control device which controls operations of the transmitting device and the receiving device, and which detects an approach by the vehicle occupant carrying the portable unit on a basis of the response signal received by the receiving device,
and wherein
each of the transmission request signals transmitted from the plurality of transmitting antennas includes identification information for identifying a corresponding one of the transmitting antennas or a corresponding one of the doors provided with the corresponding one of the transmitting antennas, and the response signal includes identification information corresponding to the identification information included in the transmission request signal received by the portable unit, and
the control device determines which of the plurality of doors is approached by the vehicle occupant carrying the portable unit on the basis of the identification information included in the response signal received from the portable unit by the receiving device.

7. An occupant approach detection method, comprising the steps of:
individually transmitting transmission request signals from a plurality of transmitting antennas provided to a plurality of doors of a vehicle in a corresponding manner, each of the transmission request signals including identification information for identifying a corresponding one of transmitting antennas or a corresponding one of the doors provided with the corresponding one of the transmitting antennas;
returning, from a portable unit having received one of the transmission request signal, a response signal including identification information corresponding to the identification information included in the received transmission request signal, the response signal serving as a response to the received transmission request signal;
receiving the response signal returned from the portable unit; and
determining which of the plurality of doors is approached by the vehicle occupant carrying the portable unit on the basis of the identification information which is included in the response signal returned from the portable unit.

8. An occupant approach detection apparatus, comprising:
transmission means which individually transmit transmission request signals from a plurality of transmitting antennas provided to a plurality of doors of a vehicle in a corresponding manner;
reception means which receives a response signal returned, as a response to one of the transmission request signals, from a portable unit having received the received the relevant transmission request signal; and
control means which controls operations of the transmission means and the reception means, and which detects an approach of a vehicle occupant carrying the portable unit based on the response signal received by the reception means,
wherein
each of the transmission request signals transmitted from the plurality of transmitting antennas includes identification information for identifying a corresponding one of the transmitting antennas or a corresponding one of the doors provided with the corresponding one of the transmitting antennas, and the response signal includes identification information corresponding to the identification information included in the transmission request signal received by the portable unit, and
the control means determines which of the plurality of doors is approached by the vehicle occupant carrying the portable unit on the basis of the identification information included in the response signal received from the portable unit by the reception means.
